(19) United States
(12) Patent Application Publication
(10) Pub. No.: US 2008/0135192 A1
(43) Pub. Date: Jun. 12, 2008

(54) MULTIPLE SECTION ROLL-UP DOOR WITH MOLDED FACADE

(76) Inventor: Matthew J. Truman, Carlsbad, CA (US)

Correspondence Address: GORDON & REES LLP, 101 WEST BROADWAY, SUITE 1600, SAN DIEGO, CA, 92101, US

(21) Appl. No.: 11/759,220

(22) Filed: Jun. 6, 2007

Related U.S. Application Data
(63) Continuation of application No. 10/663,941, filed on Sep. 16, 2003, now abandoned.

(51) Int. Cl. E06B 3/48

(52) U.S. Cl. 160/229.1

(57) ABSTRACT

A façade on a roll-up door simulates an object, for example a pair of carriage doors. A plurality of adjacent panels each carries a single panel overlay. For example, a four section garage door has one panel per section. Each panel overlay is fastened to a corresponding panel to form a panel assembly. The panel overlays in combination simulate the object. In order to make the façade, molds are taken from the object. Panel overlays are constructed from the molds. In the preferred form, a plurality of molds, each corresponding to the position and dimensions of a portion of the object having an extent corresponding to one panel on the roll-up door are taken. The overlays taken together provide a façade which is a virtual duplicate of the surface to be simulated, for example a carriage door.

### RELATED APPLICATION

This application is a continuation of U.S. application Ser. No. 10/663,941, filed on Sep. 16, 2003, by Matthew J. Truman, and entitled “MULTIPLE SECTION ROLL-UP DOOR WITH MOLDED FAçADE,” which is hereby incorporated herein by reference in its entirety, including all the drawings.

### FIELD OF THE INVENTION

The present invention relates to multiple section doors for selectively opening or closing an opening in a structure. Such doors include roll-up garage doors.

### BACKGROUND OF THE INVENTION

Track mounted roll-up garage doors are a popular and highly effective device for closing openings in garages through which cars pass. The garage doors include a plurality of coplanar rectangular panel assemblies which comprise a door for closing a garage entrance. In a nominal one car garage application, the sections may be 8 feet wide and each 1¾ or 2 feet high stacked one on top of the other to form a garage door that is 7 or 8 feet high, respectively. Each section is pivoted with respect to the next section. Bearings extending out of either side of the garage door horizontally are received in parallel tracks. The tracks are substantially L-shaped, with an arcuate bend rather than a sharp angle at the intersection of the legs. In a closed position, the door is vertically disposed. The sections are in a first, vertical position to open the garage door, a motor is energized to pull the garage door along the tracks. As the sections move sequentially from the vertical position to the horizontal position, each section pivots with respect to the next as the bearings pass through the arcuate portion. In the open position, the sections are again coplanar in a second, horizontal position. The horizontal legs of the tracks support the garage door over a position in which a car is parked.

The parallel panel assemblies are conventionally made of steel. While the unadorned steel surface is suitable for many industrial applications, it is not suitable in many residential applications. Various ways of ornamenting garage doors have been developed. In one common form of ornamentation, patterns are stamped in the outer steel surface. More recently, the simulation of a “carriage door” has become popular. A carriage door is a two-part door that opens in the middle. Left and right sections each pivot about a vertical axis at opposite sides thereof so that doors swing out. Such doors are not practical in use since they are less suited to automation than roll-up doors. They are selected to be simulated because their appearance has great appeal. It is possible to take a carriage door made of wood, use horizontal cuts to divide it into sections and pivot the sections with respect to one another so that a carriage may be converted into a roll-up door. However, such doors are very heavy in comparison to roll-up steel doors. Due to their weight, motors that are much more expensive than roll-up garage door motors would have to be used. Starting current of such motors is higher than that of motors required to lift steel doors. Additionally, once such a door is in the open, horizontal position, its entire weight is suspended over a car. A wooden door falling from a track above a car can do significant damage.

The prior art includes various arrangements for simulating carriage doors on front of a roll-up garage door. In one prior arrangement, pieces of wood sheet material such as exterior cedar plywood are affixed to the outside of a door with a flat surface. The sheet members must be framed by separate side members. In another arrangement, plastic strips, for example, polystyrene, are glued to a flat steel outer surface and protrude outwardly from the outer surface to simulate the appearance of a solid door with surface contours. The door must be placed in a jig so that the overlays may be properly positioned on the panel assemblies. This construction requires the laborious process of properly aligning the overlays on the panel assemblies. These strips have large perimeters that must be sealed. The strips and the plastic strips and steel garage door have marketing different thermal coefficients of expansion. Consequently, the adhesive interface between the strips and the panel assemblies is continuously stressed. If a small portion of the adhered layer lifts from the steel backing, the illusion of a unitary construction between the panel assembly and strip is adversely affected. The prior arrangements only provide approximations of carriage façades through the use of panels and molding. Their surfaces are not in fact surfaces of carriage door façades.

It is highly desirable to provide a roll-up door with a simulation façade that is simply in construction and which is highly reliable and which can faithfully convey the impression of a desired design.

### SUMMARY OF THE INVENTION

The present invention comprises a roll-up door including a plurality of panels, each carrying a panel overlay simulating a section of an object, for example a carriage door. A roll-up door comprises a plurality of panel assemblies pivoted with respect to one another. An object whose appearance is to be simulated on the front of the roll-up door is provided. Molds are taken from the object. Panel overlays are constructed from the molds. In the preferred form, a plurality of molds, each corresponding to the position and dimensions of a portion of the object having an extent corresponding to one panel on the roll-up door are taken. Each overlay is fastened to a corresponding panel to form a panel assembly. The overlays taken together provide a façade which is a virtual duplicate of the surface to be simulated, for example a carriage door. Other features of the invention will be further apparent in the following description.

### BRIEF DESCRIPTION OF THE DRAWINGS

The present invention is further understood by reference to the following description taken in connection with the following drawings.

Of the drawings:

FIG. 1, comprising FIGS. 1A-1D is a series of elevations illustrating a roll-up of the present invention in a closed position, intermediate positions and an open position;

FIG. 2 is a perspective illustration of the inside of a roll-up door further illustrating operating hardware;

FIG. 3 is an enlarged cross-sectional view taken along line 3-3 of FIG. 1C;

FIG. 4 is a cross-sectional illustration of door panel assemblies taken along line 4-4 of FIG. 2;

FIG. 5 is a partial rear elevation, partially broken away, of an alternative form of the panel assembly of FIG. 3;

FIG. 6 is a cross-sectional view taken along line 6-6 of FIG. 5;

FIG. 7 is an elevation of an object to be simulated by a façade;

FIG. 8 is an apparatus for taking impressions of the object of FIG. 7;

FIG. 9 is an illustration of a set of impressions; and

FIG. 10 is a mold for molded panel overlays.

### DETAILED DESCRIPTION

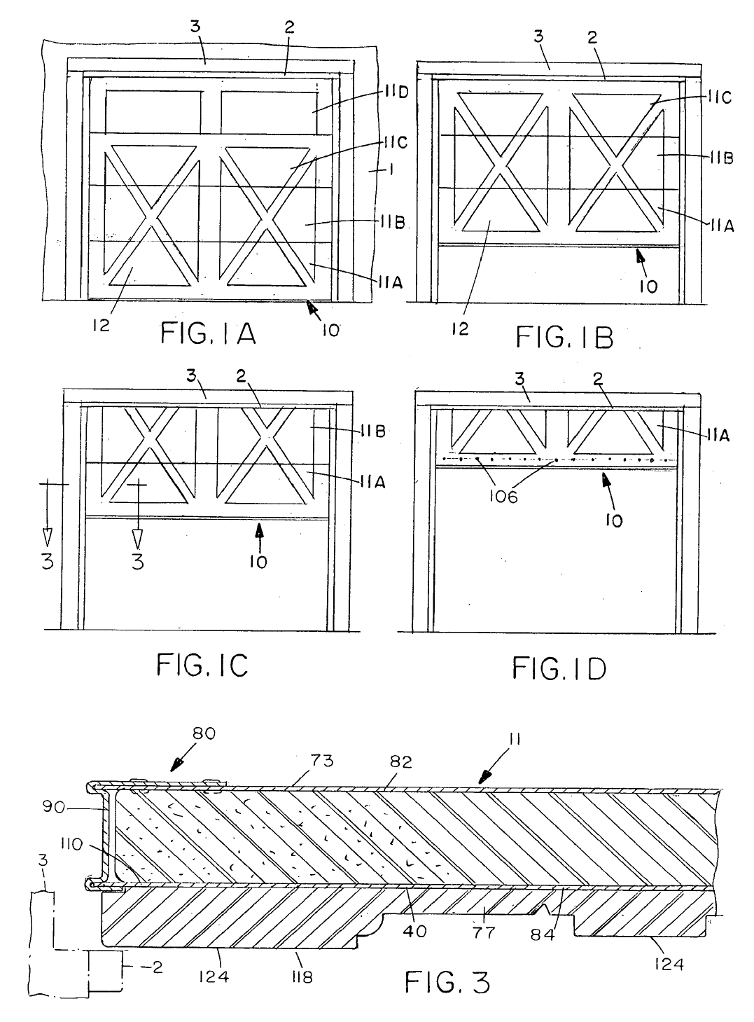

FIG. 1, consisting of FIGS. 1A through 1D, illustrates a garage 1 having a doorway 2 surrounded by a frame 3 which is closed by a garage door 10. In the embodiment illustrated in FIG. 1, the doorway 2 is of a width corresponding to a single car. In other embodiments, the doorway 2 may have a sufficient width for entry of two or more cars. In FIG. 1A, the garage door 10 is closed. In FIGS. 1B-1D, the garage door 10 is illustrated in successive stages of rolling up and opening.

The doorway 2 is closed by a roll-up door 10. The door 10 comprises panel assemblies 11 axially displaced from one another in a coplanar disposition. In the present description, “axially” is used to mean in the direction of motion. In the embodiment of FIG. 1, four panel assemblies 11a, 11b, 11c and 11d are provided. Due to the design of the embodiment of FIG. 1, it is convenient to divide the door 10 into four panel assemblies 11. In other embodiments, three or five panel assemblies 11 would be used. Other numbers of panel assemblies 11 could also be used, although this would not likely provide for greater convenience in construction or use. In the present description, the reference numeral 11 followed by a letter refers to a particular panel assembly 11. The reference numeral 11 by itself refers to any of the panel assemblies 11a-11d. The surface layers of the panel assemblies 11 form a façade 12 simulating an object for closing a particular boundary, e.g. a carriage door or a diorama.

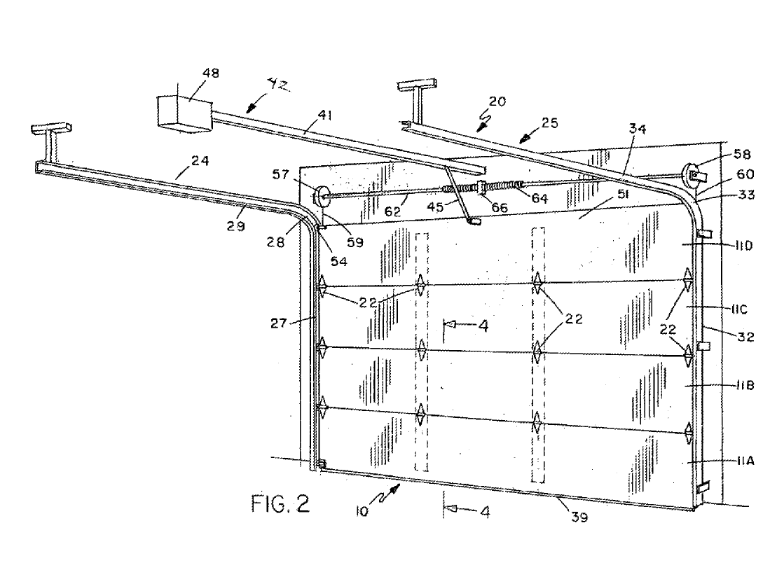

FIG. 2 is a perspective view from an interior of the garage 1 illustrating the garage door 10 mounted to mounting hardware 20. Each panel assembly 11 is pivotally mounted to a next panel assembly 11 by a plurality of hinges 22. The garage door 10 is moveable along parallel tracks 24 and 25. The tracks 24 and 25 are substantially L-shaped. The track 24 has a vertical section 27, a curved section 28 and a horizontally disposed upper section 29. Similarly, the track 25 has a vertical section 32, a curved section 33 and a horizontally disposed upper section 34. In a closed position, the garage 10 is disposed in a vertical section defined by portions 27 and 32 of the tracks 24 and 25, respectively. In an open position, the garage door 10 is disposed between sections 29 and 34 of the tracks 24 and 25, respectively. As the garage door 10 moves through the curved portions 28 and 33, one panel assembly 11 pivots with respect to a next section panel assembly by means of hinges 22.

A gasket 39 may be secured to the bottom of panel assembly 11a for cushioning during closure of the garage door 10 and for sealing the doorway 2. A screw drive unit 42 has a horizontal track 41 along which one end of a linkage 45 travels. Another end of the linkage 45 is fixed to an upper portion 51 of the garage door 10. The screw drive unit 42 is driven by a selectively energized motor and gear box unit 48. The sections 11 have bearings 54 projecting horizontally from either end thereof. The bearings 54 are received in the tracks 24 and 25. In a preferred form, cable drums 57 and 58 are mounted above the legs 27 and 32 respectively and have cables 59 and 60 extending to the bottom panel assembly 11a. The drums 57 and 58 are coaxially mounted on a torsion tube 62 coaxially mounted with a torsion spring 64 mounted to a wall of the garage 1 by a center bearing plate 66. When the garage door 10 is lowered from the open position to the closed position, the bottom panel 11a pulls on the cables 59 and 60 respectively to rotate the torsion tube 62 and apply torsion to the torsion spring 64. When the garage door 10 is lifted, the torsion in the spring 64 assists in lifting the garage door 10. By storing torsion energy in the spring 64, load requirements on the motor and gear box unit 48 are reduced.

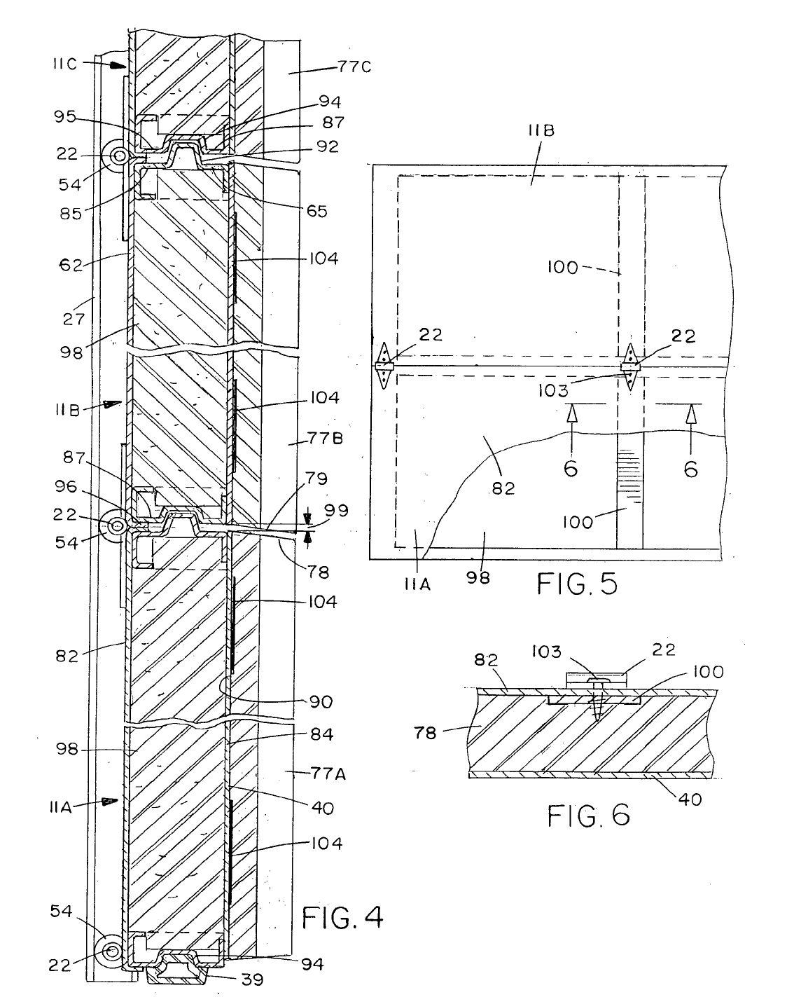

FIGS. 3 and 4 are cross-sectional views taken along line 3-3 of FIG. 1 and line 4-4 of FIG. 2, respectively. The panel assembly 11 comprises a panel 73 and a panel overlay 77. Each panel overlay 77 comprises a section of the façade 12. The same numbering convention is used for panels 73 and panel overlay 77 as that explained above for panel assemblies 11. Preferably, each panel 73 carries one panel overlay 77. The unitary panel overlay allows simulation of a number of object elements, such as molding, recesses and hardware. Alternatively, actual hardware may be affixed to one or more panel overlays 77 to further simulate a carriage door or other object. For a wide garage door 10, e.g., a sixteen foot wide door, it may be desirable to use two 8-foot wide panel overlays 77. Sixteen foot wide panel overlays are far less convenient to manufacture, handle or transport. A plurality of panel overlays 77 per panel 73 still provides the advantages of a unitary panel overlay 77 incorporating a plurality of elements of the simulated object.

Each panel 73 comprises a box 80 closed by a backsheet 82. The box 80 may, for example, be 8 feet wide by 2 feet high by 2 inches deep. A backsheet 82 for a box of these dimensions would be 2 feet by 8 feet. The box 80 has a front wall 84, top and bottom walls 85 and 87 and left and right walls 90 (only one of which is visible in the partial view of FIG. 3). In a well-known manner, the box 80 is filled with a filler member 98 (see FIGS. 3 and 4). The filler member 98 is a rectangular parallelepiped dimensioned to fill the box 80. Preferably, the filler member 98 is polystyrene foam. The filler member 98 provides sound and heat insulation. A suitable material for the panel 73 is hot dip galvanized steel according to standard A525 or A527 of the American Society for Testing and Materials (ASTM), West Conshohocken, Pa. While these standards were “withdrawn” in 1994, they continue to be specified in the garage door industry. Preferably, each panel 73 is finished with baked-on primer and paint coats. Each panel overlay has an upper transversely (perpendicular to the direction of motion) extending surface 78 and a lower transversely extending surface 79.

For sealing the garage door 10 when closed, a horizontally extending vertical boss 92 is formed in the top wall 85. A mating recess 94 is formed in the bottom wall 87. The boss 92 in a top wall of a first panel 73 fits into a recess 94 in the bottom wall of 87 of a next panel 73 thereabove. The boss 92 in one panel cooperates with the recess 74 in a next panel 73 for closure in a tongue and groove fashion when the garage 10 is in the closed position. A bottom recess 74 receives the sealing gasket 39 (FIG. 2). In a preferred form, the backsheet 82 has upper and lower horizontal extending legs 95 and 96. The legs 95 and 96 slide over top and bottom walls 85 and 87, respectively to close the box 80. This structure results in the rear of the box 80 having a vertical dimension greater than the front of the box 80. The difference in vertical dimensions is equal to the combined thickness of a leg 95 and a leg 96. Consequently, a vertical gap 99 is provided between adjacent panels 73 at the front of the garage door 10.

In accordance with an exemplary embodiment of the present invention, the panel overlays 77 are formed to block the view of the gaps 99 at contemplated viewing angles. Preferably, upper and lower surfaces 78 and 79 on panel overlays 77 other than panel overlay 77a are formed to be parallel. They are, in a preferred form, slanted downwardly at an angle θ so that the forward edge 81 of the lower surface 79 is below the bottom of the gap 99. Consequently, a viewer facing the gap 99 at eye level will not see the gap 99. It will be blocked by the upper surface 78 of a next panel overlay 77. Similarly, if a viewer faces the gap 99 from a vantage point higher than or below by less than the angle, the viewer will also not see the gap 99. Since the panel overlay may be molded as a heterogeneous piece, the visible portion of upper surface 79 will have the same color as the visible face of the panel overlay 77. The garage door 10 will give the appearance of a continuous door.

FIG. 5 is a rear elevation of the panels 77a and 77b partially broken away, and FIG. 6 is a cross-sectional detail taken along lines 6-6 of FIG. 5. A bracing member 100, comprising a metal strip, vertically extends along the length of the filler member 98 at horizontally central location thereof. The bracing member 100 is positioned inside the box 80 and is covered by the backsheet 82. A fastener 103 extends through one of the hinges 22, the backsheet 82 and the bracing member 100. FIG. 5 is partially broken away to reveal the filler member 98 and one of the bracing members 100. The use of two brace members 100 is preferable for a 12 foot wide garage door such as that illustrated in FIG. 2.

The panel overlays 77 may each be permanently fastened to one panel 73 by a number of different means. As seen FIG. 3, the panel overlay 77 may be retained to a front face of the wall 84 of the box 80 by a layer or discrete areas of glue 104. A form of glue to provide a flexible layer may be used. One suitable material for use as the glue 104 is liquid polyurethane. Additionally, a plurality of nails 106 may be used for further fastening the panel overlay 77 to the panel 73. Each nail 106 is preferably a pin nail. Many different arrangements may be used for placement of nails. For simplicity in illustration, in FIG. 1D, a plurality of dots indicate heads of nails 106. In one embodiment, nails 106 may be spaced every 4 inches.

A front surface 118 (FIG. 3) of a panel overlay 77 is molded in a mold cast from an item which the façade 12 (FIG. 1) is intended to duplicate. A rear surface 120 of panel overlay 77 is preferably and conveniently flat. Various panel overlays 77 taken together form the façade 12 of FIG. 1. A very popular façade for roll-up garage doors is the carriage door. Other shapes could be simulated such as the Star Gate from a science fiction television series, natural history scenes or other simulations comprised of designs extending over more than one panel. Relief features 124 (FIG. 3) correspond to different portions of the carriage door or other objects such as borders, cross-beams or moldings. A casting may be modified to vary depth, width or length of relief features. As can be seen in FIGS. 1 and 3, the façade has outwardly protruding features 124 which continue from one panel overlay to the next without interruption. In other words, each panel overlay has protrusions or features which align with corresponding features on the next adjacent panel overlay when the garage door is in the closed or deployed position, so as to form the desired overall scene or façade.

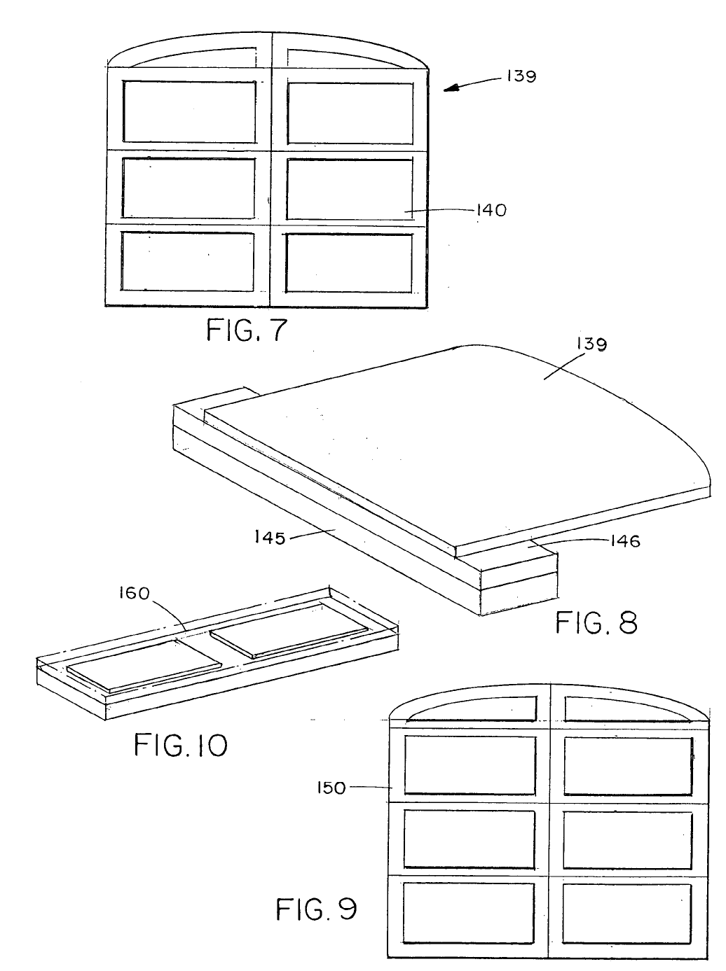

FIG. 7 is an elevation of an object 139 to be simulated by the façade 12. In the embodiment of FIG. 7, the object 139 to be duplicated is a carriage door 140. FIG. 8 illustrates an apparatus for taking impressions, and FIG. 9 illustrates a set of impressions. In order to duplicate the surface of the carriage door, a mold tray 145 is utilized to take a plurality of impressions 150 (FIG. 9) using impression material 140 preferably. The mold tray 145 covers a vertical extent of the object 139 to correspond to one panel overlay 77. The resulting impression 150 may be worked so that a resulting panel overlay 77 has a selected contour which may or may not correspond exactly to the object 139. After each impression 150 is taken, a mold 160 is formed therefrom, as seen in FIG. 10.

The above specification has been written with a view toward enabling those skilled in the art to make many modifications in particular features to provide a roll-up door constructed in accordance with the present invention.

What is claimed is:

1. A door comprising a plurality of vertically aligned panel assemblies, with each panel assembly pivotally moveable with respect to an adjacent panel assembly, wherein each panel assembly comprises a panel having an outer surface and a separate, one-piece contoured panel overlay affixed to the outer surface of the panel, the panel overlay having a shape and size the same as the panel and completely covering the outer surface, and wherein the panel overlays are arranged in place on the panels to form a façade simulating an object on the door.

2. The door according to claim 1, wherein each panel assembly has an outer face, an upper face, and a lower face, wherein the upper and lower faces of vertically adjacent panel overlays form parallel faces, and wherein the adjacent panel overlays are spaced to define a gap, the parallel faces being oriented at a predetermined angle which is not perpendicular to the outer face and which conceals the gap when viewed from an angle.

3. The door according to claim 1, wherein each panel overlay is a molded impression of a pre-selected portion of the object.

4. The door according to claim 3, wherein the panel comprises a rectangular box, and wherein the panel overlay has rectangular dimensions essentially equivalent to those of the rectangular box.

5. The door according to claim 4, wherein the object is a carriage door.

6. The door according to claim 1, wherein the panel overlay comprises molded urethane.

7. The door according to claim 1, wherein the panel overlay is adhered to the panel with glue.

8. The door according to claim 1, wherein the panel overlay is further secured to the panel with nails.
